(19) United States
(12) Patent Application Publication
(10) Pub. No.: US 2024/0141595 A1
(43) Pub. Date: May 2, 2024

(54) Rail Heaters and Methods

(71) Applicants: Craig Berger, Stockbridge, MA (US); Rosalie Berger, Stockbridge, MA (US)

(72) Inventors: Craig Berger, Stockbridge, MA (US); Rosalie Berger, Stockbridge, MA (US)

(21) Appl. No.: 18/384,869

(22) Filed: Oct. 29, 2023

Related U.S. Application Data
(60) Provisional application No. 63/421,790, filed on Nov. 2, 2022.

(51) Int. Cl. E01B 19/00

(52) U.S. Cl. CPC E01B 19/00

(57) ABSTRACT

A rail having a recess or groove therein, wherein a heater is located at least partially within the recess or groove, and a method of manufacturing same, including providing a forming a rail with a recess or groove therein, and installing a heater in the recess or groove.

### CROSS REFERENCE TO RELATED APPLICATIONS

This application claims benefit under 35 U.S.C. § 119(e) to U.S. provisional application No. 63/421,790 filed on Nov. 2, 2023, entitled “Rail Heaters and Methods,” which is hereby incorporated by reference in its entirety as if fully set forth herein.

### FIELD OF THE INVENTION

The present invention relates to heating of contact rails, sometimes referred to “the third rail.”

### BACKGROUND

Electrified railways constitute a significant portion of the world's railways, particularly in developed locales such as urban areas. A common way to deliver power to a train in such systems is via a contact rail or “third rail” that contains an electrical supply. Commonly, shoes on the rail car run or slide in contact with the energized contact rail, conducting electricity from the rail and delivering it to traction motors that drive the train wheels and other electrical systems of the train.

In colder climes, snow and ice can accumulate or build up on the contact rail. As little as 1/32-inch of ice or snow on the contact surface of the third rail can prevent adequate contact between the rail and the shoe and disrupt power transfer to the rail car. Existing contact rail heating systems possess various drawbacks, including manufacturing cost, power efficiency, thermal efficiency, repairability, and controllability.

### SUMMARY

In one aspect, the invention is directed to rail heaters or heated rails, e.g., contact or “third” rails. A heater or heating element, or multiple heating elements, is installed or partially embedded into the rail, e.g., into a recess or groove in the rail. In at least some embodiments, the rail has a rail body that includes a web and a head connected to the web. The recess or groove is in the external or exterior surface of the head. A heating element is located or embedded at least partially within the recess. In some embodiments, the heater is located or embedded entirely within the recess. In some embodiments, the shape of the heater conforms or at least substantially conforms to the shape of the recess. A heater wherein at least 50 percent of the surfaces of the heater by area contact a corresponding or adjacent surface of the groove (where one exists) would be considered to be substantially conforming.

In at least some embodiments, the head, such as at the recess or groove, and the heater define an interference or press fit with each other. The interference or press fit serves to, at least in part, to retain the heating element in the groove. In some such embodiments, the interference/press fit fully retains the heater in the recess. In some embodiments, retainers such as clips or other types of retainers assist in or backup the retention of the heater in the groove. In some embodiments, the recess is in a surface of the head that is opposite of or on the underside of the contact surface of the rail.

In another aspect, the recess defines an opening located at the exterior/external surface. A cladding is attached to the rail, enclosing the opening. In some such embodiments, the cladding retains the heating element in the groove. In some such embodiments, there is no interference or press fit between the rail and the heater. In some embodiments, the heater extends through or past the opening of the recess. In some such embodiments, the cladding has a recess or opening to receive the portion of the heating element that extends past the opening.

In a further aspect, a heated rail may be made or manufactured by providing or forming a rail body defining a web and a head connected to the web, and a recess located in an exterior surface of the head, wherein the recess is configured to form an interference fit with the heater. The heater is then installed at least partially into the recess. In at least some embodiments, the heater is installed by press-fitting or force-fitting the heater into the recess. In some such embodiments, the installation deforms the heater material. The rail, including the recess, may be formed or made by any suitable process that is currently-known or later becomes known.

In yet another aspect, a cladding is attached to the rail, covering or enclosing the heater. In some such embodiments, the heating element is located entirely in the recess. The recess defines an opening at the outer surface of the head, and the cladding encloses or covers the opening. In other embodiments, the heater extends through or past the opening. In some such embodiments, the cladding has a recess or opening so that, upon attaching the cladding, the portion of the heater extending past the opening is received within the recess of the cladding. The cladding may be attached to the rail by any suitable process that is currently-known or later becomes known.

Though certain embodiments herein are described with respect to a rail heater and methods of making same, the invention may be utilized in other apparatus and uses.

Other objects and advantages of the present invention will become apparent in view of the following detailed description of the embodiments and the accompanying drawings.

### BRIEF DESCRIPTION OF THE DRAWINGS

FIG. 1 is a schematic illustration of a cross-section in a vertical plane of a contact rail;

FIG. 2 is an enlarged view of a portion of the contact rail of FIG. 1; and

FIG. 3 is a schematic illustration of across-section in a vertical plane of another contact rail.

### DETAILED DESCRIPTION

Various embodiments are described with respect to the accompanying figures.

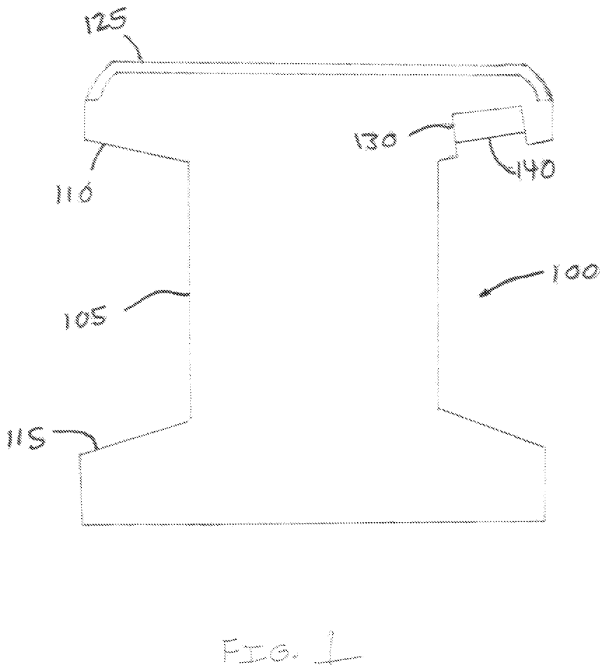

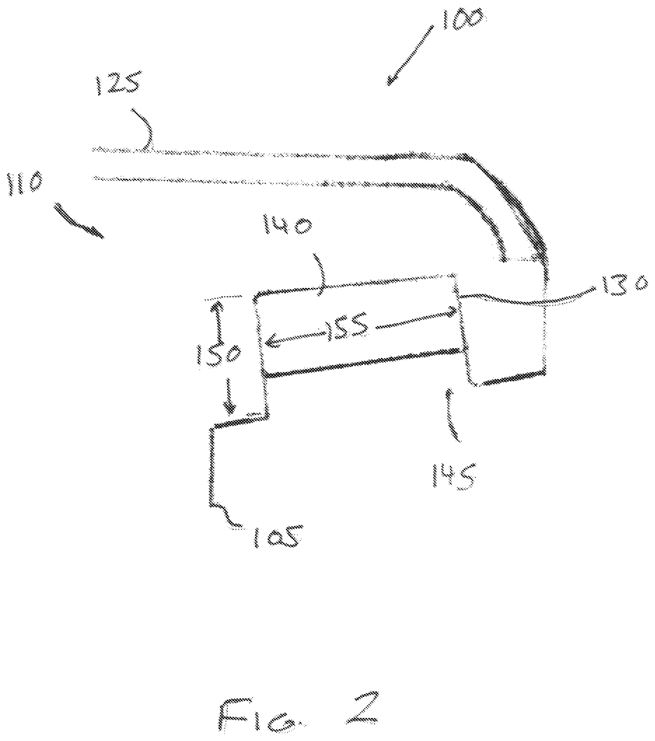

Referring to FIGS. 1 and 2, contact or “third rail” 100 constitutes a web 105, a head 110 and a foot 115. The head 110 has a contact surface 125 that a rail car shoe (not shown) contacts to draw electricity from the rail 100. In the illustrated embodiment, the contact surface 125 is a different material than the rest of the rail 100. In this common type of rail construction, the contact surface 125 constitutes an electrically-conductive wear surface that protects the body of the contact rail 100 from wear from contact with the shoe. In the illustrated embodiment, the rail 100 is clad with the contact surface 125, which may be fabricated according to techniques that those of ordinary skill in the art would understand. In some embodiments, the body of the rail 100 is aluminum or aluminum alloy, and the contact surface 125 is stainless steel. The aluminum material is lightweight (relative to steel materials) and a good electrical and thermal conductor, while the stainless steel provides increased wear resistance. Those in the art, though, should understand that other contact rail constructions that are known or will be become known may be utilized with the invention. In other embodiments, for example, the contact surface 125 is homogenous with the rest of the head material. For example, the entire rail may be steel.

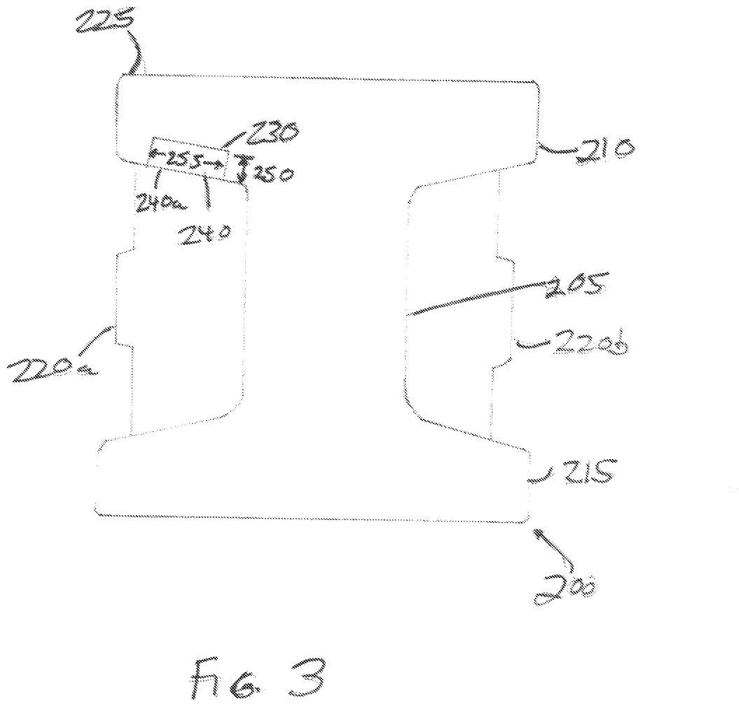

Those of skill in the art should further understand that, though the embodiment shown in FIG. 1 has the head 110 at the vertical top of the rail 100, in railway systems in which the shoe runs along the underside of the rail 100, the head 110 with its contact surface 125 may be located at the vertical bottom of the rail 100. In effect, the embodiment shown in FIG. 1 may be vertically “flipped” so that head 110 is at the vertical bottom. Likewise for the embodiment shown in FIG. 3.

As seen in FIGS. 1 and 2, the head 110 has a recess or groove 130 therein (the terms “recess” and “groove” are used interchangeably herein). The recess 130 extends longitudinally along a least a portion of the rail 100, i.e., in a direction of travel of the train. A heater element 140 is located within the groove 130, extending longitudinally along at least a portion thereof.

As can be seen in the illustrated embodiment, the recess 130 defines an opening 145 of the recess 130. The recess 130 defines a depth 150 extending from the opening 145, a width 155 generally traverse to the depth 150. As illustrated, the thickness of the heater 140 is less than the depth 150 of the recess 130, though it should be understood that the heater 140 may have a different thickness, including but not limited to a thickness about equal to the depth 150 of the groove 130, or greater than the depth 150, i.e., the heater 140 protrudes beyond the opening 145 of the groove 130.

The heater 140 may be generally constructed in a similar manner as known contact rail heater elements, which should be understood by those of ordinary skill in the art. However, it should be appreciated that the heater 140 may be constructed in any suitable manner.

In at least some embodiments, including the embodiments illustrated, the shape, e.g., cross-section, of the heater 140 substantially conforms to the shape, e.g., cross-section of the recess 130. This permits substantial contact between the heater 140 and the interior surfaces of the recess 130, permitting heat conduction from the heater 140 to the head 110. In other embodiments, though, the shape of the heater 140 does not substantially conform to the shape of the recess 130.

The rail 100 may be made or manufactured in any suitable manner. In at least one embodiment, the body of the rail 100 is formed with the recess 130 therein. For example, the rail with the recess 130 may be extruded. However, the rail with the recess may be formed in other manners, as will be appreciated by those of skill in the art. The heater 140 is then inserted or installed into the recess 130.

In at least some embodiments, the heater 140 defines an interference fit in at least some locations along the longitudinal length of the groove 130 (the terms “interference fit,” “press fit” and “friction fit” are used interchangeably herein). This interference fit requires that the heater 140 be press fit, force fit or even shrink fit (e.g., it is inserted while the head 110 is in a heated state, such as before it cools after forming) into the groove 130. In at least some such embodiments, the inference fit retains the heater 140 in the grove 130 without the need for retainers or clips. In some such embodiments, the interference fit is defined so that the interference fit is retained under expected operating conditions, e.g., cold and/or hot conditions wherein differential thermal expansion between the heater 140 and the head 110 may alter the fit therebetween. Those of ordinary skill in the art should understand how to provide such interference fits.

In at least some of the above-discussed embodiments, the press-fitting deforms the heater material to further conform the heater to the configuration of the recess. This increases the area of contact between the heater and the recess, improving heat transfer between the heater and the rail body.

In yet other embodiments, though, there is no interference fit. In such embodiments, the heater 140 may be retained in the groove 130 by any suitable means that are currently known or later become known. Non-limiting examples include clips, retainers, fasteners, bolts, brazing welding, and chemical bonding. In yet other embodiments in which the head is located at the vertical bottom of the rail, the opening of the recess can be located in the vertical upward portion of the recess, such that the heater may be at least in part be held in position by gravity.

The ends of the heater 140 (not shown) may contain terminals or connections to which wires or leads may be connected to deliver electrical power to the heater 140. Typical systems draw power for heating from the contact rail, which the positive lead connected (direction or indirectly) to the contact rail, and the negative lead connected to a running rail, or, in so-equipped systems such as those used in systems New York City and Washington, D.C., a separate cable. However, any suitable power supply and configuration may be used.

While powered, the electrical resistance of the heater material causes power to be converted to heat, which heat is conducted from the heater 140 to the head 110 (and other parts of the rail) and heats it so as to melt ice or snow thereon or prevent/inhibit accumulation on the contact surface 125. Accordingly, adequate contact between the shoe and contact surface 125 is maintained to power the rail car(s).

In FIG. 3, another contact rail is indicated generally by the reference numeral 200. The contact rail 200 contains generally similar components as rail 100 described above, and therefore like reference numerals preceded by the numeral “2” instead of the numeral “1” are used to indicate similar elements.

One difference between rail 200 and rail 100 is the rail construction. Rail 200 includes cladding 220a, 220b attached to either side of the web 205, e.g., by bolting. This common type of contact construction allows, for example, a lighter (thinner) web construction, with additional strength provided by the cladding 220a, 220b. Another difference is that the contact surface 225 constitutes the same material as the rest of the head 210. In this manner, for example, the web 205, head 210 and foot 215 may be steel, which provides a durable wear surface 225, and the cladding 220a, 220b may be aluminum extrusions, which is a lighter material than steel, has much higher electrical conductivity than steel (for conducting the power), and has higher thermal conductivity. Another difference is that the thickness of the heater 240 is about equal to the depth 250 of the groove 230. Those in the art should understand, however, that the heater thickness may be different from that shown in FIG. 3, e.g., lesser in thickness. In yet other embodiments, the heater 240 is thicker than the depth 250 of the groove 230 so as to protrude from the groove 230. In such embodiments, the cladding 220a includes a cavity or recess (not shown) to receive the protruding portion of the heater.

One aspect of the cladding 220a is that it covers or encloses the recess 230. This places a barrier between the heater 240 and the ambient elements, which decreases heat loss due to exposure to cold air, wind, and precipitation, thus increasing the thermal efficiency of the rail heating. In embodiments where the outer surface 240a of the heater 240 is substantially in contact with the cladding 220a, e.g., the embodiment shown in FIG. 3, such contact provides additional surface area for thermal transfer from the heater 240, increasing thermal efficiency. This may be particularly true where the head material is, for example steel, and the cladding 220a is, for example, aluminum, which has a higher thermal conductivity than steel.

Manufacturing of the rail 200 may be similar to that of rail 100, at least initially. That is, the heater 240 may be installed into the groove of the head 210 similarly as discussed above. The cladding 220a (and 220b) is subsequently installed. In some such embodiments, the cladding 220a, may, at least in part, maintain the heater 220 in position in the groove 230. In such embodiments, the heater 240 may be maintained in the groove 230 without an interference fit therebetween.

The invention provides several advantages over previously-known contact rail heater systems. First, contact rail heaters are typically applied to standard contact rails in the field. That is, they are applied to the standard-form contact rails that are already installed on the railway. Such field work by nature entails certain inefficiencies, may involve taking lines out of service while the work is done, impacting railway capacity and time schedules, and, when work is done on or near an active railway, presents safety issues.

In contrast, the rails disclosed herein may be fabricated entirely in a factory, plant, or off-site location (i.e., not on the railway itself). Such fabrication is inherently more efficient than field-work, can be conducted under more controlled conditions, and avoids the railway impact and safety issues discussed above. The contact rail with the heater fully installed may then be installed on the railway as a singular piece. Those or ordinary skill should understand, though, that the present invention is not limited to fabrication or construction in any particular location, and can occur in the field.

As another advantage, previous field-applied heaters are typically retained with spring-clips or other types of clips or retainers. These retainers can fail, e.g., though corrosion or mechanical damage, leading to portions of the heater losing contact with the rails, and thus diminishing if not locally losing rail heating, and overall decreasing rail heating, decreasing heater effectiveness. Conversely, in the invention, particularly embodiments in which the heater is retained by an interference-type fit, or by cladding, movement or dislodgement of the heater is essentially prevented.

In addition, previous field-applied heaters are typically applied in long circuits up to 500-750 feet long. Failure of the heater at any location along this length, requires replacement of the entire circuit. This involves working in hundreds of feet of track section, in which the entire length of failed circuit must be removed and a new heater circuit installed, including removal and re-installation of dozens if not hundreds or heater retainers/clips, with concomitant time, costs and railway impacts.

On the other hand, because the inventive rails include a separate heater for each contact rail length (which is typically 39 feet long), only the failed length need be replaced, not hundreds of feet. This involves merely removing failed rail and replacing it with a new one, which from a labor perspective is far less time-consuming and costly, with consequently fewer and shorter railway impacts. Moreover, replacement rail sections can be maintained “in stock” and thus readily available, minimizing the time between failure and repair completion.

Those in the art should also note that, because in the invention the heater is at least partially if not fully enclosed by the rail material itself, it is far more protected from the elements and from other types of damage than were prior heaters. Prior heaters, as discussed above, are simply attached to the rail surface, and much more exposed. Thus, rails according to the invention are less likely to fail in the first place.

Furthermore, the invention is substantially more energy and thermally efficient than prior heaters. As discussed above, prior heaters contact the rail on a single surface. That contact can be limited to almost point contact in nature. This limits the amount of heat transfer between the heater and the rail. As also noted above, a large portion if not the majority of the prior heaters were exposed to the elements. This causes significant heat loss to the ambient environment through direct radiation of heat, conduction by surrounding cold air, and convention by wind or other air movement against the heater. These heat losses and thermal inefficiencies must be compensated by additional electrical power consumption.

The above is mitigated in the invention. As discussed above, in the invention, the heater, being at least partially embedded in the rail itself, is much less exposed to the ambient environment, if at all, significantly reducing heat loss to the environment, i.e., wasted heat. Additionally, as seen for example in FIGS. 1-3, the heater element is in contact with the rail material on multiple sides, if not all sides. This provides increased heat conduction from the heater. Notably, a significant portion of that contact is with the head 110/210 itself. Accordingly, the head, which is the portion to be kept clear of snow/ice, conducts heat directly from the heater itself.

The result is much greater efficiency. For example, the minimal power requirement with prior art heaters is about 30 Watts per linear foot, rising to about 40 W/linear ft. in the northern U.S. and Canada, such as in Boston or Toronto, respectively. In contrast, the invention requires only 15-21 W/linear foot. The invention doubles efficiency, from about 40% of power converted to heat in prior heaters to up to 80% in the invention.

The invention also provides significantly increased controllability of the railway heating system. As discussed above, prior heating systems run circuits hundreds of feet long. Such long circuit lengths thus constitute the smallest section of heater that can be independently controlled.

In the invention, as each rail section contains a separate heater, the heating of each rail section can be controlled independently from the other. For example, where there are 39-foot rail sections as discussed above, heating for each 39-foot section of track can be controlled separately, if desired. Alternatively, sections of rail can be “spliced together” to create desired circuit lengths for control purposes.

This permits increased localized control of heating, and thus power consumption. Controllers, e.g., PLCs, can control the power delivered to an individual heating circuit and thus the heat output of that circuit. The controllers may, e.g., utilize algorithms to determine necessary/desired heat output of a particular circuit which, for example, can depend on local conditions at that circuit. Such conditions may include, for exemplary purposes only, temperature, wind, humidity, snow/ice accumulation, etc., and/or any other relevant or desired parameters. Those parameters/conditions may be different at different locations along the track, even locations that are relatively close to each other. The invention permits more discrete control, such that locations that requirement more heat output are delivered more power, while others that require less heat output are delivered less, decreasing overall power consumption and cost.

In the case of prior heaters with the circuits being hundreds of feet long, the ability to adjust for local conditions is more limited. Therefore, power delivered to a circuit must address the worst-case conditions along the length of that circuit to ensure that no portion lacks adequate heating. This may result in other portions of the circuit receiving an unnecessary amount of power. This not only wastes money, but can increase pollution and other environmental degradation (such as climate change), and decrease the service life of overpowered/overheated portions of the circuit.

As should be understood to those of ordinary skill in the art, this description is not intended to disclose all possible embodiments of the invention and combinations of features thereof, and this description should not be interpreted to apply only to the specific exemplary apparatuses described herein or the exemplary methods described herein, or exemplary combination of features. That is, the inventors expressly contemplate that the invention includes any combination or sub-combination of features described herein, regardless of whether such are explicitly described or shown herein.

As may be recognized by those of ordinary skill in the pertinent art based on the teachings herein, numerous changes and modifications may be made to the above-described and other embodiments of the present disclosure without departing from the spirit of the invention as defined in the claims. For example, though the embodiments described above relate to the contact rails, the invention is not limited to that application, and may be utilized in other applications. As another example, though the illustrated embodiments show the recess located in the head, the recess may be located elsewhere in the rail, including but not limited to the web and the foot. Further, though the illustrated embodiments show the recess located on the side opposite the contact surface of the head, the recess may be located at another location on the head, including but not limited to the side of the head or in the contact surface. While the illustrated embodiments show one recess and one heating element, the rail may contain multiple recesses/grooves heaters. As a further example, though the heaters and recesses in the illustrated embodiments are shown to have a generally rectangular cross-sectional shape, they may have any suitable or desired cross-sectional shape. Further the cross-sectional shape may vary along the length of the rail. Accordingly, this detailed description of embodiments is to be taken in an illustrative, as opposed to a limiting sense.

What is claimed is:

1. A rail comprising:
a rail body having a web and a head connected to the web;
a recess located in an exterior surface of the head; and
a heater located at least partially within recess,
wherein the head and the recess define an interference fit, wherein the interference fit is configured to at least partially retain the heater within the recess.

2. A rail comprising:
a rail body having a web and a head connected to the web;
a recess located in an exterior surface of the head, the recess defining an opening located at said exterior surface;
a heater located within recess; and
a cladding attached to the rail body and enclosing the opening.

3. A method comprising:
(i) providing or forming a rail body defining a web and a head connected to the web, and a recess located in an exterior surface of the head; and
(ii) installing a heater at least partially located in the recess, wherein the heater and the recess define an interference fit;
wherein the installing step includes press-fitting the heater into the recess.

4. A method comprising:
(i) providing or forming a rail body defining a web and a head connected to the web, and a recess located in an exterior surface of the head;
(ii) installing a heater into the recess, the recess defining an opening located at said exterior surface; and
(iii) attaching a cladding to the rail body and enclosing the opening with the cladding.
